(19) United States
(12) Patent Application Publication
(10) Pub. No.: US 2002/0124541 A1
(43) Pub. Date: Sep. 12, 2002

(54) Forage additive application system and method

(76) Inventors: James M. Oepping, Wilton, IA (US); Jeffrey S. Roberts, Hudson, WI (US)

Correspondence Address: MCKEE, VOORHEES & SEASE, P.L.C., ATTN: PIONEER HI-BRED, 801 GRAND AVENUE, SUITE 3200, DES MOINES, IA, 50309-2721, US

(21) Appl. No.: 10/140,596

(22) Filed: May 7, 2002

Related U.S. Application Data
(63) Continuation of application No. 09/679,771, filed on Oct. 5, 2000, now abandoned.

(51) Int. Cl. A01D 61/00

(52) U.S. Cl. 56/16.4 R

(57) ABSTRACT

A forage additive application system of the present invention is adapted to apply a additive onto forage without first mixing the concentrated additive with a large volume of water. The application system includes a separate water tank and additive container. As water is pumped through a nozzle, the forage additive is injected into the water at a rate dependent upon the desired additive application rate.

### BACKGROUND OF THE INVENTION

1. Field Of The Invention

The present invention relates to the application of forage additives. More particularly, though not exclusively, the present invention relates to a method and apparatus for applying forage additives in order to enhance silage and stored crop preservation.

2. Problems In The Art

Forage additives are used to enhance silage and stored crop preservation. For example, when silage is created by driving a chopper through a field, the harvested silage is often sprayed with inoculants as the silage is being harvested. A typical silage inoculant includes one or more strains of microorganisms, enzymes, bacteria, yeast, and/or other chemicals. One problem with the inoculant is that if the inoculant is placed in a large holding tank as is usually the case, all of the inoculant must be used in a specified period of time or else the inoculant is no longer usable. As a result, any left over inoculant is usually discarded or wasted.

In one example, an additive is comprised of a water soluble crop inoculant which may be applied at an application rate of 0.1-10 grams per ton of silage. This type of inoculant is mixed with water at ratios between 1:200 to 1:3000. The mixture is sprayed on the crop as it are being harvested by harvesting equipment. Once mixed with water, the inoculant must be used within a specified period of time.

The chemical injection of agricultural chemicals involves two basic injection methods, high pressure pump injection and differential pressure injection. High pressure pump injection is a more common method to accomplish the ratio and flow rates desired.

### FEATURES OF THE INVENTION

A general feature of the present invention is the provision of a method and apparatus for applying forage additives which overcomes problems found in the prior art.

A further feature of the present invention is the provision of a method and apparatus for applying forage additives wherein the additive is contained in a small separate tank which is inline injected into a water stream.

Further features, objects, and advantages of the present invention include:

A method and apparatus for applying forage additives which allows the additive to be stored overnight or for a longer period of time.

A method and apparatus for applying forage additives which uses a display unit to display the total amount of the crop which has been sprayed with the forage additive.

A method and apparatus for applying forage additives with a high degree of accuracy.

A method and apparatus for applying forage additives which permits the refrigeration of the additive if not used within a certain time.

These as well as other features, objects and advantages of the present invention will become apparent from the following specification and claims.

### SUMMARY OF THE INVENTION

The forage additive application system of the present invention is used to apply forage additives onto silage, hay, high moisture corn, and other agricultural crops. The invention is comprised of a water source and at least one spray nozzle connected together with a fluid conduit. The water is pumped through the conduit and the spray nozzle while the concentrated forage additive is injected into the conduit at rate related to the desired application rate of the additive.

### BRIEF DESCRIPTION OF THE DRAWINGS

FIG. 1 is a view of a silage chopper with a forage additive application system of the present invention.

FIG. 2 is a schematic diagram of the forage additive application system of the present invention.

FIGS. 3-5 show the container and the acceptor used with the present invention.

FIG. 6 is a view of a controller used with the present invention.

FIG. 7 is a view of an injection pump used with the present invention.

### DETAILED DESCRIPTION OF THE PREFERRED EMBODIMENT

The present invention will be described as it applies to its preferred embodiment. It is not intended that the present invention be limited to the described embodiment. It is intended that the invention cover all alternatives, modifications, and equivalencies which may be included within the spirit and scope of the invention.

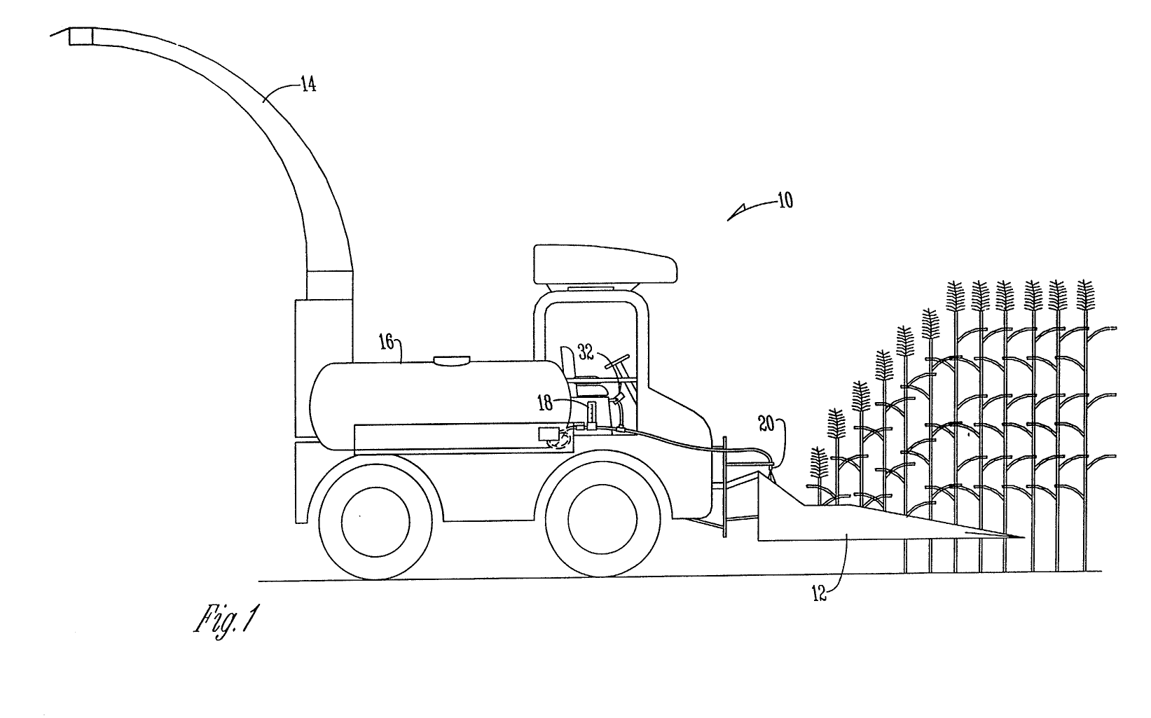

FIG. 1 shows a self propelled silage chopper 10 including a cutter 12 and a discharge chute 14. While FIG. 1 shows a chopper, and the description describes a chopper, it is understood that the present invention could be used with other harvesting and handling equipment such as bailers, combines, roller mills, blowers, etc. Also, the invention could be used to apply forage additives on various crops, including, but not limited to silage, hay, high moisture corn, and other agricultural crops. The types of chemicals sprayed by the present invention is also not limited to forage additives. For example, the invention could be used to spray other chemicals including herbicides, insecticides, fertilizers, etc. In addition, the invention could be used to spray inoculants with other additives. The present invention could also be used in other applications as well.

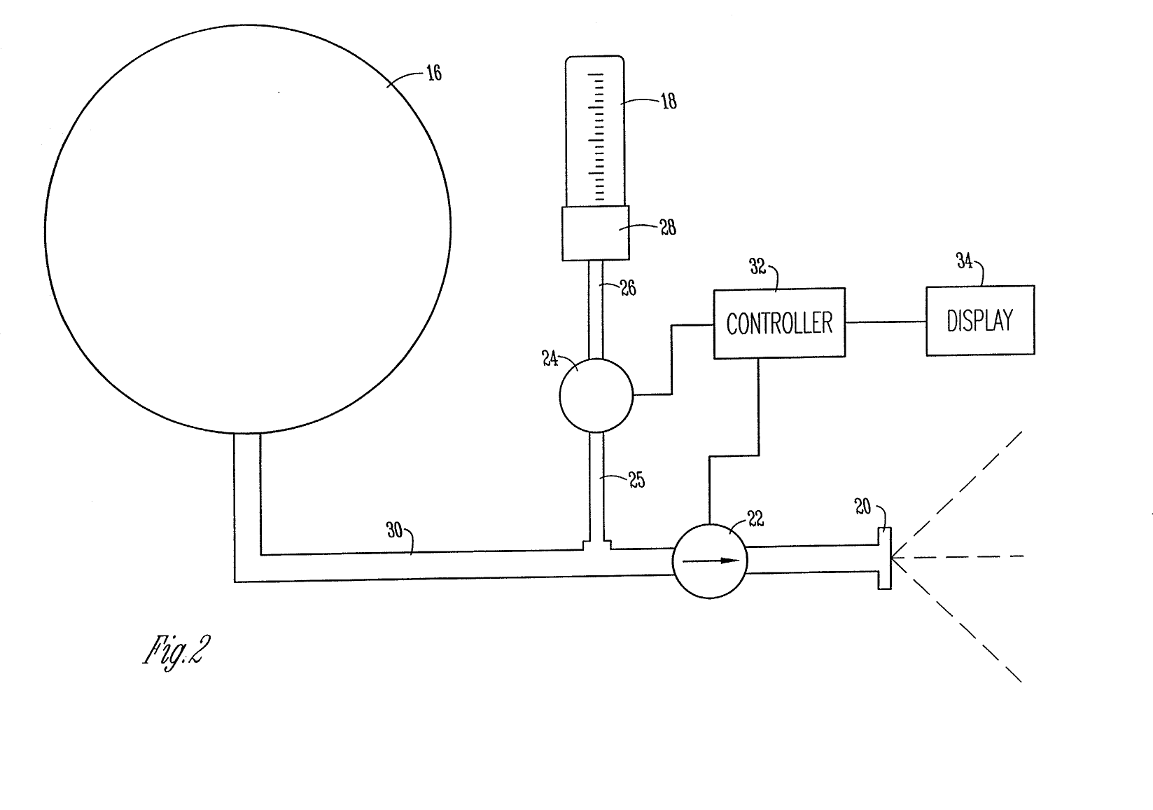

The chopper 10 includes a water tank 16 as well as a smaller forage additive container 18. The tank 16 and container 18 are both operatively connected to a spray nozzle 20 for applying a mixture of water and forage additives onto the silage harvested by the chopper 10. While FIG. 2 shows only one container 18, more containers 18 could be used simultaneously (see FIG. 8, for example). Similarly, a plurality of spray nozzles could also be used.

FIG. 2 is a schematic diagram of the forage additive application system of the present invention. The system shown if FIG. 2 could be used in combination with various harvesting and handling equipment as mentioned above. FIG. 2 shows the water tank 16, the forage additive container 18, and the nozzle 20 described above. FIG. 2 also shows a main pump 22 as well as an injection pump 24. The injection pump 24 is in communication with the container 18 via a line 26 and a custom vessel acceptor 28 (described below). Alternately, the injection pump 24 and the vessel acceptor 28 could be formed as a single unit rather than as separate units. The injection pump 24 is also in communication with the main pump 22 via the line 25 as well as with the main water tank 16 via the line 30. The main pump 22 is also in communication with the nozzle 20. When the main pump 22 is activated, water from the water tank 16 is pumped through the nozzle 20 and onto the harvested silage (FIG. 1). The main pump 22 will primarily pump water from the main water tank 16, but will also pump the appropriate amount of forage additives depending on the operation of the injection pump 24 (described below). Therefore, by controlling the main pump 22 and the injection pump 24, the user can precisely control the mixture of water and forage additives which are sprayed through the nozzle 20.

FIG. 2 also shows a controller 32 and a display unit 34 which are operatively connected to the injection pump 24 and the main pump 22. Preferably, the controller 32 and display 34 are located within the cab of the chopper 10 allowing the user to control the forage additive application system. The controller 32 and display 34 are described in more detail below.

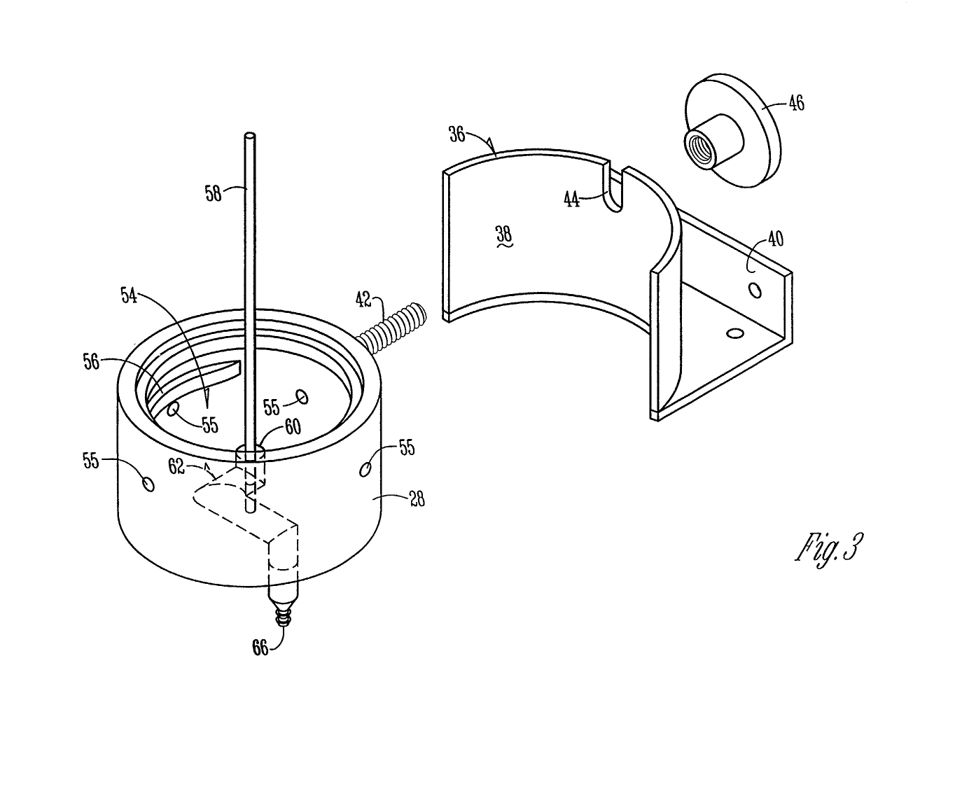

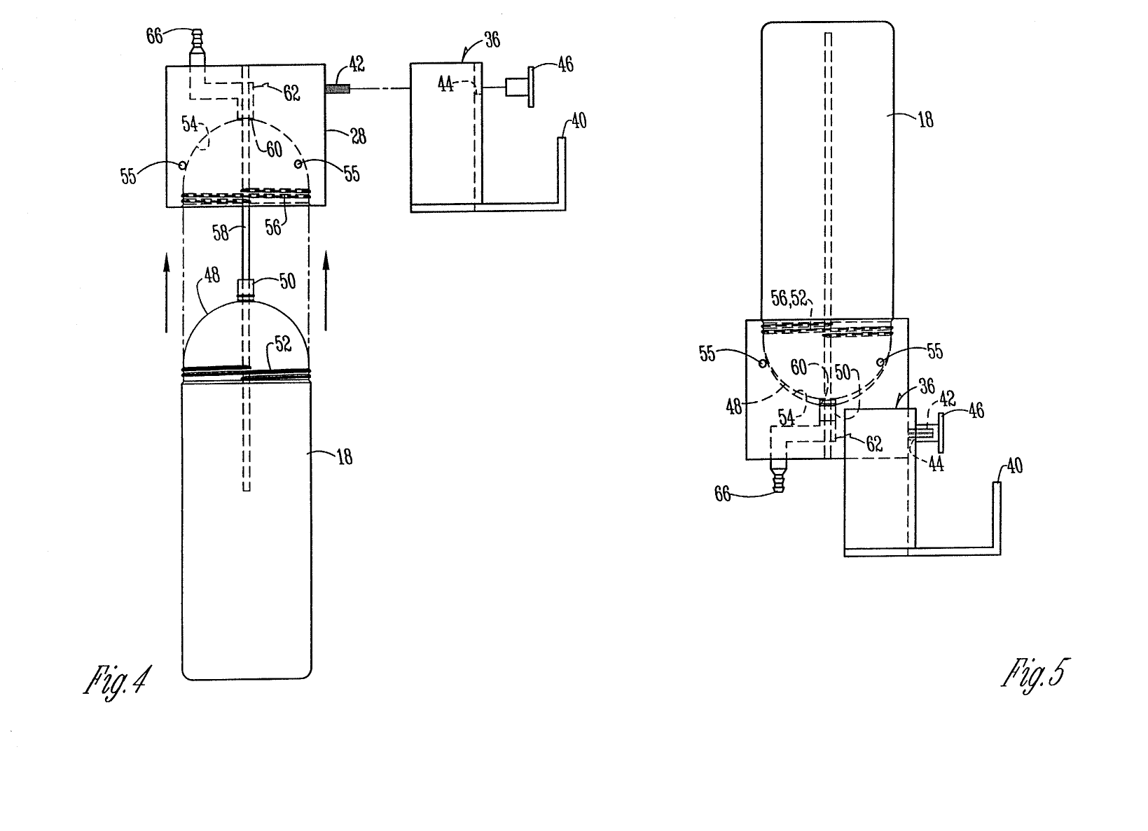

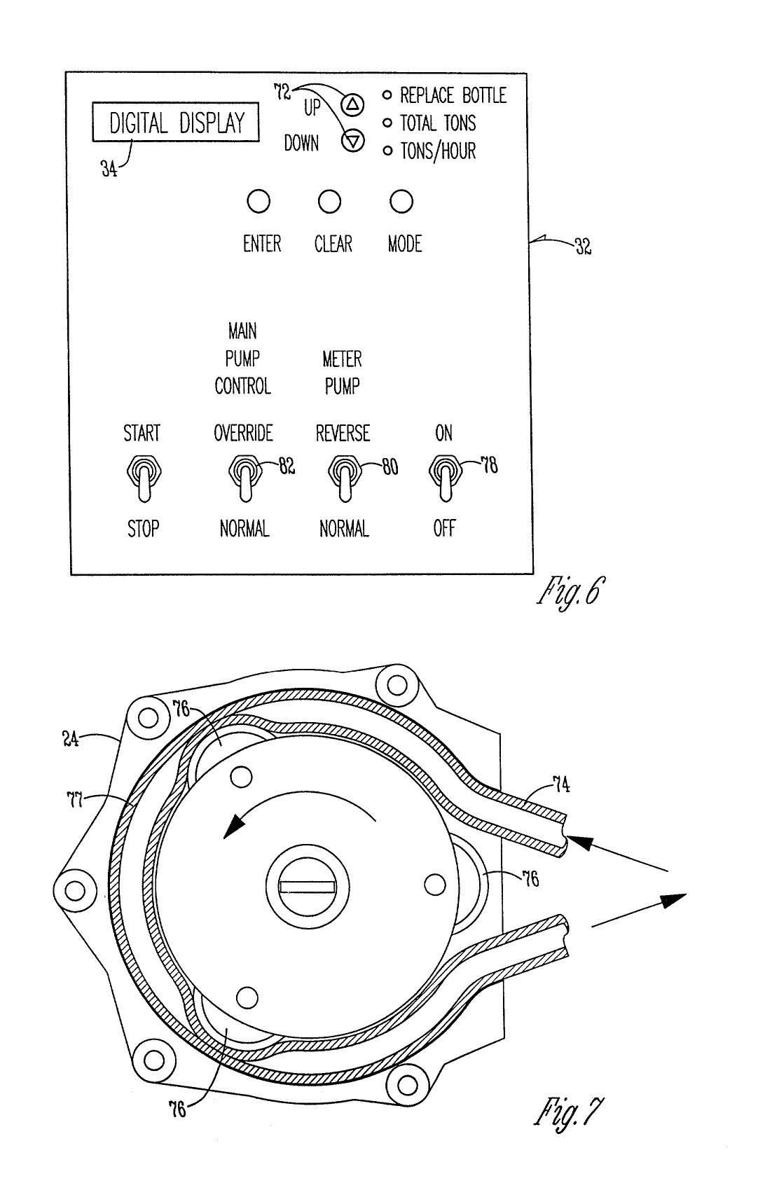

FIG. 3 is an exploded view of the vessel acceptor 28. FIGS. 4 and 5 show views of the vessel acceptor 28 in combination with the container 18. A steel bracket 36 includes a curved surface 38 which matches the curved surface of the acceptor 28. The bracket 36 also includes a mounting plate 40 which can be bolted to the chopper 10 to hold the bracket 36 in place. A threaded stud 42 extends from the vessel acceptor 28 and can be placed within the groove 44 formed in the curved surface 38 of the bracket 36. The vessel acceptor 28 can be placed within the curved surface 38 of the bracket 36 with the threaded stud 42 placed within the groove 44 and secured in place by a threaded set knob 46. As a result, the vessel acceptor 28 can be releasably secured to the bracket 36 in two different orientations (described below).

As shown in FIG. 4, the container 18 is adapted to be inserted within the vessel acceptor 28. The container 18 is preferably comprised of a blow molded plastic container having a generally cylindrical bottom portion and a dome-shaped upper portion 48. Formed on the upper portion 48 is an opening 50 which may be fitted with a cap (not shown) prior to use. The container 18 also includes a number of threads 52 formed below the upper portion 48. The vessel acceptor 28 includes a cavity 54 which is shaped to receive the upper portion 48 of the container 18. A number of ventilation holes 55 are formed in the cavity 54 to prevent the use of improper containers. The vessel acceptor 28 also includes a set of threads 56 which can be threaded onto the threads 52 of the container 18. When the container 18 is screwed into the vessel acceptor 28, an air vent tube 58 is inserted through the opening 50 and the opening 50 engages a lip seal 60 so that the inside of the container 18 will be in communication with a series of channels 62 formed within the vessel acceptor 28. The air vent tube 58 lets air into the container 18 as the contents of the container 18 are pumped out.

As shown best in FIG. 3, port 66 connects to the line 26 shown in FIG. 2. The container 18 and vessel acceptor 28 are used in the following manner. In the preferred embodiment, the user will purchase a container 18 having a quantity of forage additive in a powder form. Before the forage additive can be used, it must be converted to a liquid form. To accomplish this, the user fills the container 18 half full with water and shakes the container vigorously. The container 18 is then filled to a “fill to here” line on the container. Then, the contents are shaken again to assure a good mix. The user will then attach the container 18 to the acceptor 28 as shown in FIG. 4. At this point, the container 18 contains a forage additive concentrate. Once the mixture is mixed satisfactorily, the container 18 and vessel acceptor 28 are inverted 180° and mounted to the bracket 36 as shown in FIG. 5.

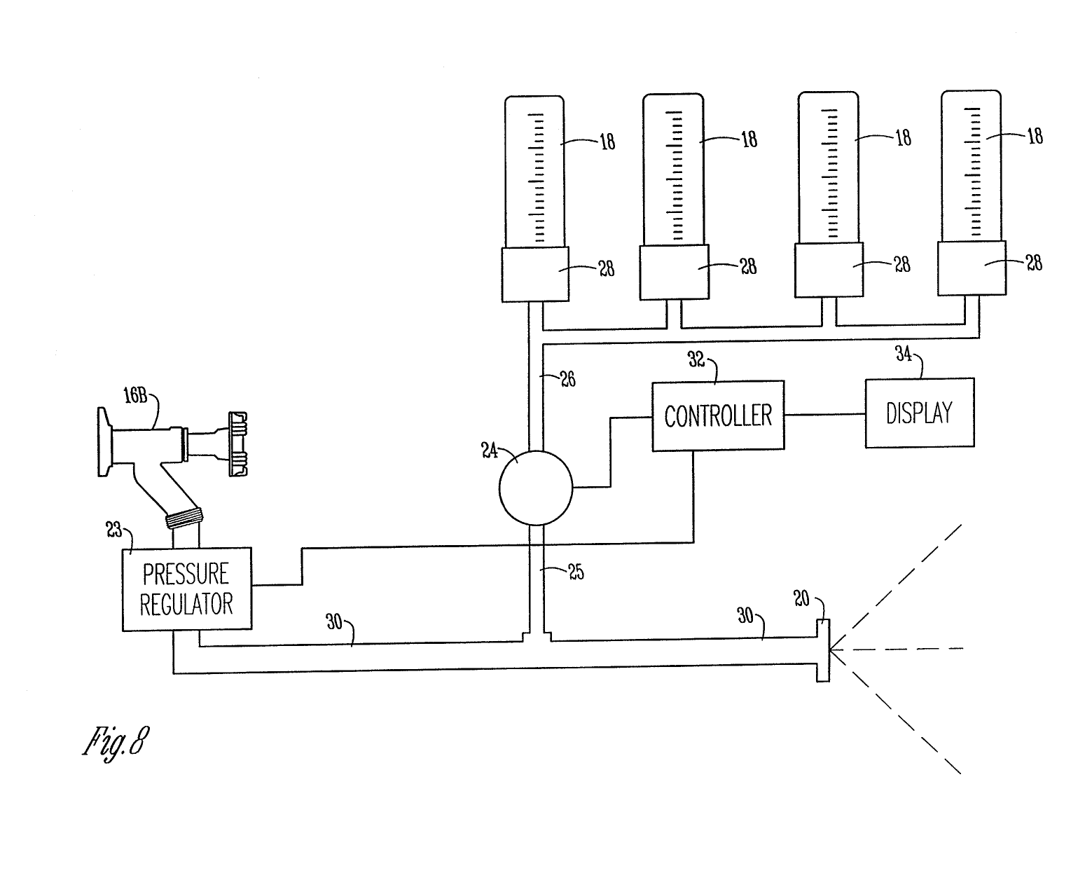

FIG. 6 shows a view of a controller 32 and display 34 which is mounted within the cab of the chopper 10. The controller 32 and display 34 may be separate (FIG. 2) or may be housed in the same unit (FIG. 6). The controller 32 includes a number of push buttons and toggle switches which are used to control the various operational modes of the present invention. The controller 32 includes a pair of up/down buttons 72 which the user can use to select a rate for applying forage additive in tons per hour, for example. The controller 32 also includes a main pump control override switch 82 which may be used to bypass the controller 32 and run the main pump at the highest possible rate. The display 34 is capable of displaying various information including the number of tons of forage which have been treated (based on the amount of forage additive that the pump 24 has pumped), the rate (in tons/hour), etc. The controller 32 has several LEDs which provide indications such as when the container 18 is low (based on the pump 24 operation), what is being displayed on the display 34, etc.

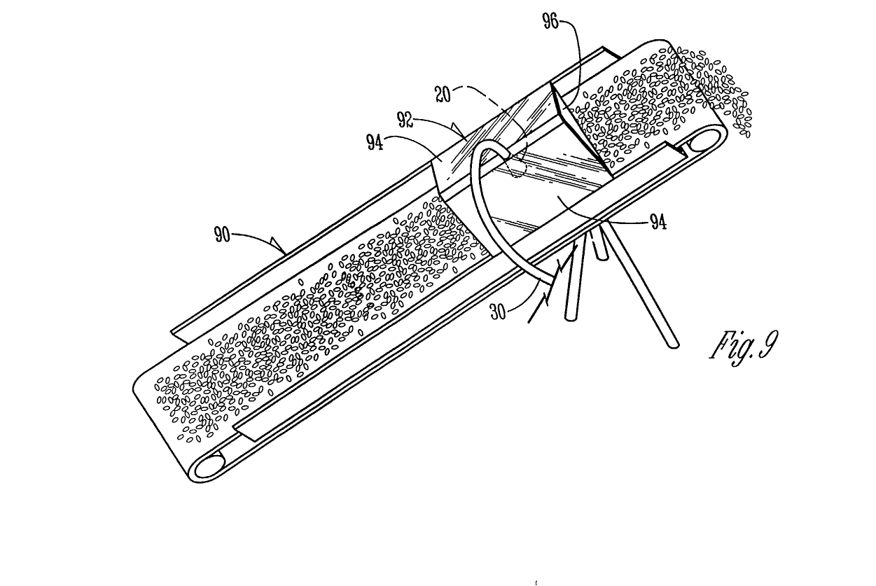

The injection pump 24 is capable of precisely controlling the amount of forage additive injected into the water line 30. To precisely control the injection of the forage additive, a peristaltic pump is used. FIG. 7 is a sectional view of the injection pump 24. The injection pump 24 itself is an off-the-shelf item and is not the subject of the present invention.

A peristaltic pump works in the following manner. A length of resilient tubing 74 extends within the pump in a circle as shown. A series of three rollers 76 are positioned 120° apart as shown. As the rollers 76 are rotated, they press opposite sides of the tubing 74 together as shown. This creates a precise volume 77 of trapped liquid between two adjacent rollers 76. As the rollers 76 rotate counterclockwise, this precise volume 77 between adjacent rollers 76 is expelled from the pump 24. A series of these precise volumes 77 of liquid are expelled at a rate of three times per revolution. Therefore, by precisely controlling the rotation of the roller 76, the amount of forage additive pumped through the pump 24 can be precisely controlled. The flow through the pump 24 can also be reversed by rotating the roller 76 clockwise. One suitable peristaltic pump is the model 900-0627 manufactured by Barnant Company.

The present invention operates as follows. As mentioned above, the user will purchase a container 18 of forage additive in powder form. The user first fills the container 18 half full with water and shakes the container 18 vigorously. The user then fills the container 18 to the “fill to here” line. Then, the contents are shaken again to assure a good mix. The user then attaches the container 18 to the acceptor 28 and inverts the container 18 and vessel acceptor 28 and mounts them to the bracket 36 (FIG. 5). The controller 32 shown in FIG. 6 includes an on/off switch 78. With the power turned on, the user may select an application rate by pressing the up/down buttons 72. When the user starts operating the chopper 10, the main pump 22 and injection pump 24 are activated. As the main pump 22 pumps water from the tank 16 through the nozzle 20, the injection pump 24 will inject a precise amount of forage additive into the line 30. In this way, a precise amount of forage additive will be sprayed on the silage through the nozzle 20.

When the user is finished harvesting silage, the unused forage additive disposed within the lines between the line 30 and the container 18 can be pumped back into the container 18. The controller 32 includes a backflush switch 80 which reverses the rotation of the rollers 76 within the pump 24 shown in FIG. 7. When the pump 24 is reversed, the forage additive within the tubing 74 and the lines extending from the pump 24 flow backwards and back into the container 18. Since the forage additive is a different color than the water, the user will know when to stop the backflush of forage additive in order to prevent water from the tank 16 to be drawn into the container 18. Because of the backflush process, the forage additive which pumped out of the container 18, but not sprayed on the silage, will not be wasted. After the backflush process, the container 18 can be removed and refrigerated for later use.

FIGS. 8 and 9 show an alternate embodiment of the present invention. When high moisture corn is harvested, it is often sprayed with inoculants to enhance the preservation of the corn. FIG. 8 is a schematic diagram of an inoculant application system similar to the system shown in FIG. 2, although the system will not be installed on harvesting equipment. FIG. 8 shows a water source 16B (a hydrant), four inoculant containers 18, and a nozzle 20. Four inoculant containers are used to accommodate the high volume of corn that will be inoculated. The system can accommodate any number of containers. Since a water source 16B is used, the main pump 22 is not necessary. However, a pressure regulator 23 is used to maintain a desired pressure, and therefore, a desired spray rate. The injection pump 24, controller 32, and display 34 are the same as those described above.

The inoculant is applied to the high moisture corn as the corn is elevated into a corn bin. FIG. 9 shows a belt conveyor 90 being used to convey corn into a bin or bunker (not shown). While FIG. 9 shows a belt conveyor, other conveying devices could be used such as augers, etc. Because of potential high wind conditions present on the belt conveyor 90, a shroud 92 is used to house the spray nozzle 20 to prevent wind from blowing the inoculant away before is can be applied to the corn. The shroud is comprised of two opposing panes of Plexiglas 94 disposed at angles and two opposing ends 96 comprised of sheet metal. The shroud allows the inoculant to be sprayed on the corn without being effected by the wind.

The preferred embodiment of the present invention has been set forth in the drawings and specification, and although specific terms are employed, these are used in a generic or descriptive sense only and are not used for purposes of limitation. Changes in the form and proportion of parts as well as in the substitution of equivalents are contemplated as circumstances may suggest or render expedient without departing from the spirit and scope of the invention as further defined in the following claims.

What is claimed is:

1. An apparatus for spraying forage additives on agricultural crops comprising:
a water source;
a spray nozzle;
a conduit connected between the water source and the spray nozzle for communicating liquid from the water source to the spray nozzle;
a first pump in communication with the conduit for pumping water from the water source to the spray nozzle;
a forage additive container; and
an injection pump in communication with the container for injecting forage additives from the container into the conduit.

2. The apparatus of claim 1 wherein the injection pump is located upstream from the first pump.

3. The apparatus of claim 1 further comprising a controller for controlling the operation of the injection pump, wherein the controller causes the forage additive to be injected at a rate related to a desired forage additive application rate.

4. The apparatus of claim 3 wherein the desired additive application rate is entered into the controller by a user.

5. The apparatus of claim 1 wherein the injection pump is comprised of a peristaltic pump.

6. The apparatus of claim 1 wherein the injection pump is comprised of a reversible pump.

7. The apparatus of claim 1 further comprising an additive container acceptor for holding the additive container, the forage additive container acceptor further comprising a port being in communication with the injection pump.

8. The apparatus of claim 7 further comprising a bracket for securing the forage additive container acceptor to a support structure in either an upright or an inverted position.

9. The apparatus of claim 1 wherein the apparatus is used on harvest equipment.

10. The apparatus of claim 9 wherein the harvest equipment is comprised of a chopper.

11. The apparatus of claim 10 wherein the apparatus is used to spray forage additives on silage while harvesting the silage using the chopper.

12. The apparatus of claim 9 wherein the harvest equipment is comprised of a bailer.

13. The apparatus of claim 10 wherein the apparatus is used to spray additives on hay while bailing the hay using the bailer.

14. The apparatus of claim 9 wherein the harvest equipment is comprised of a combine.

15. The apparatus of claim 1 wherein the water source is comprised of a water tank.

16. The apparatus of claim 1, wherein the apparatus is used to spray forage additives on high moisture corn as the high moisture corn is being moved by a conveying device, the apparatus further comprising a shroud disposed above the conveying device for blocking wind, the spray nozzle being disposed at least partially within the shroud.

17. The apparatus of claim 1 further comprising a display unit for displaying information relating to the apparatus.

18. The apparatus of claim 17 wherein the information relates to the amount of agricultural crop that has been sprayed with additives.

19. The apparatus of claim 1 wherein the forage additive is comprised of an inoculant.

20. A method of treating silage, hay, high moisture corn, or other agricultural crops comprising the steps of:
providing a source of water;
providing a container of concentrated additive;
providing a conduit between the source of water and a spray nozzle;
pumping water from the source of water through the conduit and the spray nozzle onto the crop as the crop is being harvested; and
injecting additives from the container into the conduit at a rate related to the desired application rate of the additive.

21. The method of claim 20 wherein the additive is injected into the conduit using an injection pump connected between the container and the conduit.

22. The method of claim 21 further comprising the step of reversing the injection pump to draw additives back into the container.

23. The method of claim 20 further comprising the steps of:
providing a container acceptor;
connecting the container to the container acceptor; and
providing a fluid connection between the container acceptor and the conduit.

24. The method of claim 23 further comprising the step of placing the contents of the container in communication with the first fluid connection to allow the contents of the container to be injected into the conduit.

25. The method of claim 20, wherein the silage, hay, high moisture corn, or other agricultural corps are treated with additives while harvesting the crops using harvesting equipment.

26. The method of claim 20 further comprising the step of displaying information relating the application of forage additives.

27. The method of claim 20 further comprising the step of displaying information relating to the amount of the agricultural crop that has been treated.

28. The method of claim 20, wherein the method is used to spray additive on high moisture corn, the method further comprising the steps of:
providing a conveying system for conveying the high moisture corn;
providing a shroud disposed above the conveying system to block any wind; and
positioning the spray nozzle at least partially within the shroud to spray additives onto the high moisture corn as it passes below the shroud.

29. An apparatus for spraying a liquid material on agricultural crops comprising:
a water source;
a spray nozzle;
a conduit connected between the water source and the spray nozzle for communicating liquid from the water source to the spray nozzle;
a first pump in communication with the conduit for pumping water from the water source to the spray nozzle;
a container for containing the liquid material to be sprayed; and
an injection pump in communication with the container for injecting the liquid material from the container into the conduit.
